(19) United States
(12) Patent Application Publication
(10) Pub. No.: US 2022/0338423 A1
(43) Pub. Date: Oct. 27, 2022

(54) AGRICULTURAL STAKE TO SUPPORT PLANTS AND ASSOCIATED METHODS

(71) Applicant: FLORIDA AGRICULTURAL STAKES, LLC, OAKLAND, FL (US)

(72) Inventor: Kenneth D. IRELAND, Oakland, FL (US)

(21) Appl. No.: 17/812,303

(22) Filed: Jul. 13, 2022

Related U.S. Application Data
(63) Continuation-in-part of application No. 17/306,296, filed on May 3, 2021.
Application No. 17/306,296 is a continuation of application No. 16/514,257, filed on Jul. 17, 2019, now Pat. No. 10,999,979.
(60) Provisional application No. 63/221,188, filed on Jul. 13, 2021.
(60) Provisional application No. 62/699,248, filed on Jul. 17, 2018.

(51) Int. Cl. A01G 9/12

(52) U.S. Cl. CPC A01G 9/122; B29L 2031/7004

(57) ABSTRACT

An agricultural stake to support plants includes a fiberglass reinforced plastic (FRP) elongated member comprising a top end and a bottom end, and a textured exterior surface. The agricultural stake includes an elongated member comprising a thin walled tube having a top end and a bottom end, and the elongated member comprises fiberglass reinforced plastic and exhibits no flex memory. The elongated member has an exterior surface texture configured to provide purchase to a line attached to the elongated member, where the exterior surface texture is formed by an abrasive.

### RELATED APPLICATIONS

This application claims priority to U.S. Provisional Application Ser. No. 63/221,188 filed on Jul. 13, 2021 and is a continuation-in-part of pending U.S. patent application Ser. No. 17/306,296 filed May 3, 2021 which is a continuation of U.S. patent application Ser. No. 16/514,257 filed Jul. 17, 2019, now U.S. Pat. No. 10,999,979 issued May 11, 2021 which claims priority to U.S. Provisional Application Ser. No. 62/699,248 filed on Jul. 17, 2018, the contents of which are herein incorporated by reference in their entirety.

### TECHNICAL FIELD

The present invention relates to the field of agriculture, and, more particularly, to an agricultural stake to support plants and associated methods.

### BACKGROUND

Stakes are generally formed of wood for the physical support of plants. The availability of wood for the stakes has been reduced over the years as demand for wood has increased. In addition, wooden stakes have a limited life span in the field requiring the constant replacement as the wood stakes degrade over time.

Metal stakes have been introduced as a replacement to the wood stakes. However, the cost of metal stakes is high and the metal stakes rust over time and must also be replaced periodically.

Accordingly, what is needed in the art is an agricultural stake that is cost effective, does not require periodic replacement, and can be easily implemented in the field with existing stake driving equipment.

### SUMMARY

In view of the foregoing background, it is therefore an object of the present invention to provide an improved agricultural stake. The agricultural stake includes an elongated member comprising a thin walled tube having a top end and a bottom end, where the elongated member may comprise fiberglass reinforced plastic and exhibits no flex memory. The elongated member has an exterior surface texture configured to provide purchase to a line attached to the elongated member.

The exterior surface texture may be formed by an abrasive, abrasive blasting, sand blasting, or sandpaper abrasion, for example. The exterior surface texture of the elongated member is non-linear.

The elongated member may also include a cap secured over the top end of the elongated member and configured to withstand a force used to drive the elongated member into a ground surface. The elongated member may comprise an ellipse cross section, an oval cross section, a rectangular cross section, an octagonal cross section, or a polygon cross section, for example. A diameter (i.e., cross sectional shape) of the elongated member may be consistent along its length and comprise an extruded material.

In another particular aspect, an agricultural system to support plants is disclosed. The system includes a plurality of stakes spaced apart from each adjacent stake in a plurality of rows. Each stake of the plurality of stakes comprises an elongated member comprising a thin walled tube having a top end and a bottom end, where the elongated member exhibits no flex memory. The elongated member has an exterior surface texture configured to provide purchase to a line attached to the elongated member.

In another aspect, a method of making an agricultural stake to support plants is disclosed. The method includes extruding an elongated member that may be comprised of fiberglass reinforced plastic to form a thin walled tube having a top end and a bottom end and exhibits no flex memory. The method also includes creating an exterior surface texture on the elongated member. The exterior surface texture may be created by abrasive blasting, sand blasting, or sandpaper abrasion, for example. The exterior surface texture is non-linear.

### BRIEF DESCRIPTION OF THE DRAWINGS

FIG. 1 is an elevational view of an agricultural stake in accordance with a particular embodiment of the invention;

FIG. 2 is a cross sectional view taken in the direction of line 2-2 of FIG. 1;

FIG. 3 is a detailed elevational view of a top end of the agricultural stake of FIG. 1;

FIG. 4 is a bottom view of the agricultural stake taken in the direction of line 4-4 of FIG. 1;

FIG. 5 is a top view of the agricultural stake taken in the direction of line 5-5 of FIG. 1;

FIG. 6 is a cross sectional view of the agricultural stake of FIG. 1 in accordance with an alternative embodiment of the invention;

FIG. 7 is a cross sectional view of the agricultural stake of FIG. 1 in accordance with yet another alternative embodiment of the invention;

FIG. 8 is a perspective view of the agricultural stake being abraded to create a textured exterior surface; and

FIG. 9 is a perspective view of a plurality of the agricultural stakes with the textured exterior surface.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

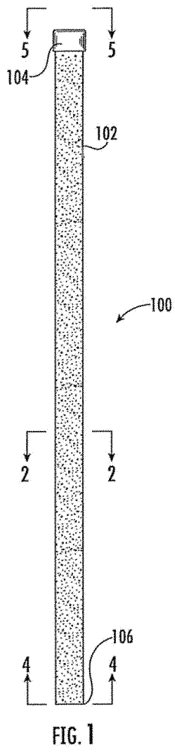

Referring now to FIG. 1, a stake 100 is shown that is used to support plants in the field. The stake 100 is relatively lightweight but strong enough to have wire, line, string, or similar material strung between successive stakes 100 in the field. Accordingly, the stake 100 may be advantageously formed of extruded material such as fiberglass reinforced plastic (FRP) material, for example. The stake 100 comprises little to no flex memory but does allow some flex in order to bend during bad weather and high winds while under a full production weight load without breaking.

The stake 100 includes an elongated member 102 that is generally a thin walled tube. The elongated member 102 is generally consistent over the length so that it may be readily extruded. This minimizes the cost of items formed in accordance with this invention. The stake 100 may have an outside diameter of ¾ inches with a wall thickness 110 of approximately 4 mm. Those of ordinary skill in the art can appreciate that other dimensions and relative dimensions of the elongated member 102 may be employed.

In particular, the diameter of the stake 100 is selected to handle various weight loads through the growth of a plant up to fill maturity. For example, a pattern of seventy-five inch long stakes 100 dispersed within a field may withstand a 75,000-80,000 pound weight load per acre. The length of the stakes 100 may vary between forty to seventy-five inches, for example, depending on the plants to support. An individual stake 100 may withstand to over fifty-five plus pounds, which equates to over 190,000 pounds per acre.

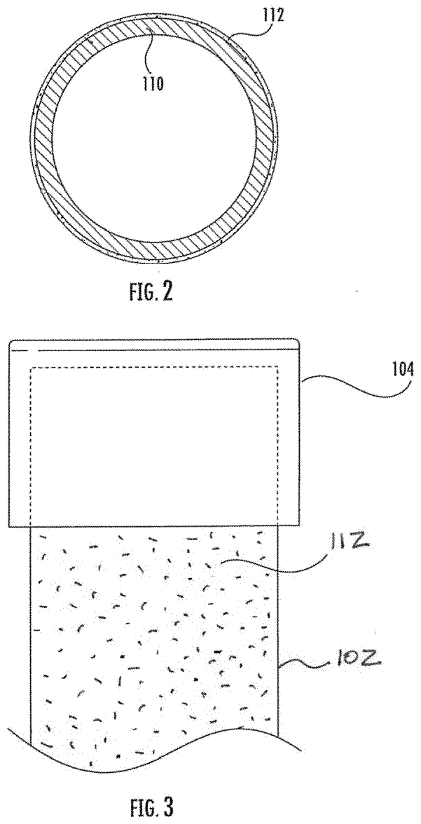

The exterior surface of the elongated member as shown in FIG. 2, comprises a textured exterior surface 112 that has been abraded. The textured exterior surface 112 may be created on the elongated member by an abrasive, abrasive blasting, sand blasting, sand paper abrasion or other methods known to those of ordinary skill in the art. The exterior surface texture is non-linear and random. The textured exterior surface provides purchase for a line attached thereto. As explained above, the stakes 100 may be installed in a field in rows with a line extending laterally between stakes 100 that is used to support growing plants, such as tomatoes. The textured exterior surface 112 is important so that the line does not slip down the stake 100 in the field.

The stake 100 may also include a fire-retardant additive that allows the stake 100 to withstand the commercial burning process after harvesting. Torch heat can be excessive and the stake 100 is configured to handle the extreme temperature without melting or loss of memory. Further, the stake 100 may have an ultraviolet (UV) protection additive that contributes to the relatively long field life of twelve to fifteen years.

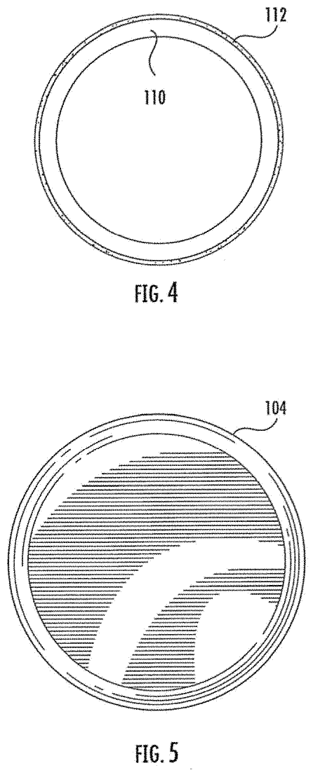

In addition, a cap 104 may be secured over a top end of the stake 100 as shown best in FIG. 3. A top view of the cap 104 is shown in FIG. 5 having a circular shape in this particular aspect. Accordingly, a bottom end 106 of the stake 100 as shown in FIG. 4 is configured to be driven into the ground using mechanical means without damaging the structural integrity of the stake 100 itself. The cap 104 may be comprised of FRP or a different material than the elongated member 102. For example, the cap 104 may be comprised of a metal such as aluminum and secured to the top end of the elongated member 102 using an adhesive. The cap 104 may also be ASA plastic or other plastic.

Thus, the stakes 100 formed in accordance with the present invention may be driven into the ground and placed in spaced relation in a row of stakes 100. Wires or lines are then strung between the stakes 100 to support vines and conventional connectors may be employed for connecting them to the stakes 100. The stakes 100 are inexpensive and substantially impervious to sprays, fertilizers and atmospheric conditions.

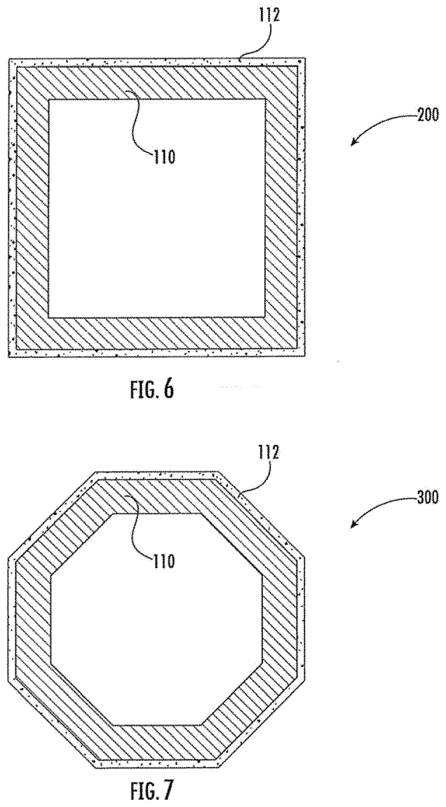

The cross-section shape of the stake 100 is not limited to a cylindrical or circular shape. In a particular aspect a stake 200 has a rectangular or square cross-sectional shape, as shown in FIG. 6. In another particular aspect a stake 300 has an octagonal cross-sectional shape as shown in FIG. 7. As those of ordinary skill in the art can appreciate, the cross-sectional shape of the stake is not limited to the examples disclosed herein but can be any other cross-sectional shape that can be extruded.

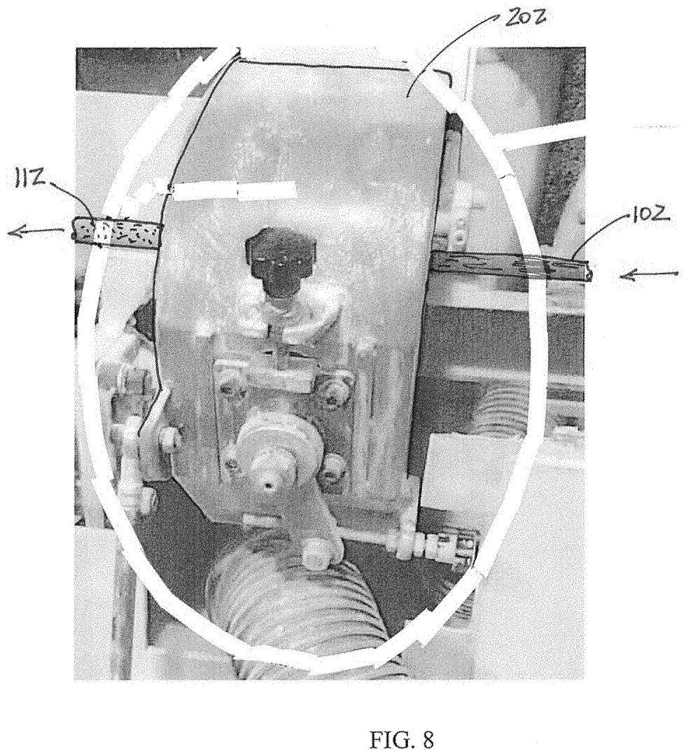

A method of making the agricultural stake 100 to support plants described above includes extruding an elongated member that may be comprised of fiberglass reinforced plastic, for example, to form a thin walled tube having a top end and a bottom end and exhibiting no flex memory. The method also includes abrading the exterior surface to create an exterior surface texture thereon as shown in FIG. 8. The elongated member 102 may be passed through an abrading machine 202 that creates the exterior surface texture 112 on the elongated member 102. The abrading machine may use compressed air to eject grit at a high velocity at the exterior surface of the elongated member 102. The grit causes dimples and other imperfections on the surface to create the exterior surface texture 112.

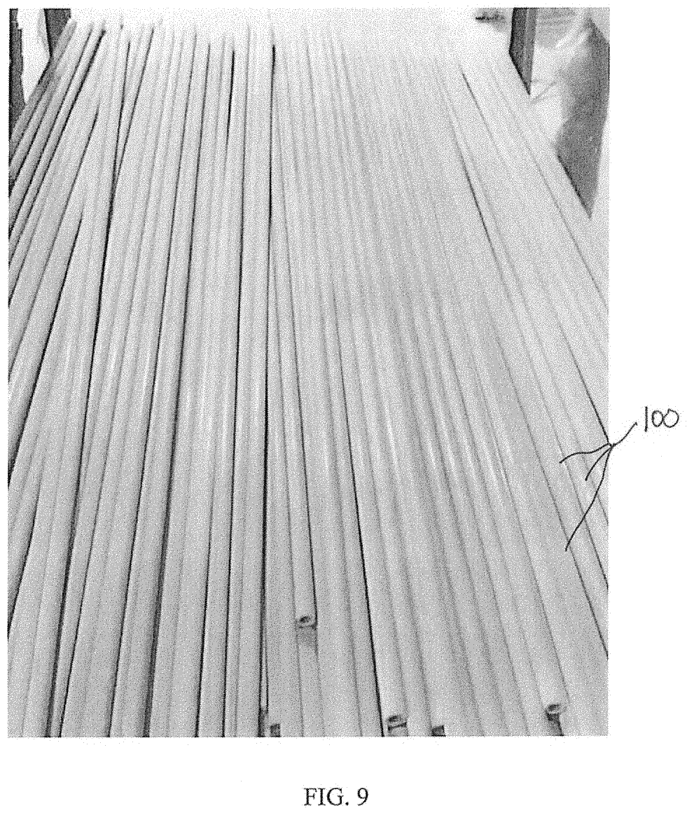

The exterior surface texture 112 may be created by abrasive blasting, sand blasting, sandpaper abrasion, for example, or other similar methods as those of ordinary skill in the art can appreciate. A plurality of the agricultural stakes 100 with the textured exterior surface are shown in FIG. 9. The method may also include securing a cap to a top end of the elongated member.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. An agricultural stake to support plants, the agricultural stake comprising:
an elongated member comprising a thin walled tube having a top end and a bottom end, wherein the elongated member exhibits no flex memory;
wherein the elongated member has an exterior surface texture configured to provide purchase to a line attached to the elongated member.

2. The agricultural stake of claim 1, wherein the exterior surface texture is formed by an abrasive.

3. The agricultural stake of claim 1, wherein the exterior surface texture is formed by abrasive blasting.

4. The agricultural stake of claim 1, wherein the exterior surface texture is formed by sand blasting.

5. The agricultural stake of claim 1, wherein the exterior surface texture is formed by sandpaper abrasion.

6. The agricultural stake of claim 1, wherein the exterior surface texture is non-linear.

7. The agricultural stake of claim 1, further comprising a cap secured over the top end of the elongated member and configured to withstand a force used to drive the elongated member into a ground surface.

8. The agricultural stake of claim 1, wherein the elongated member comprises an ellipse cross section.

9. The agricultural stake of claim 1, wherein the elongated member comprises an oval cross section.

10. The agricultural stake of claim 1, wherein the elongated member comprises a rectangular cross section.

11. The agricultural stake of claim 1, wherein the elongated member comprises an octagonal cross section.

12. The agricultural stake of claim 1, wherein the elongated member comprises fiberglass reinforced plastic.

13. The agricultural stake of claim 1, wherein a diameter of the elongated member is consistent along its length and comprises an extruded material.

14. An agricultural system to support plants, the agricultural system comprising:
a plurality of stakes spaced apart from each adjacent stake in a plurality of rows, wherein each stake of the plurality of stakes comprises,
an elongated member comprising a thin walled tube having a top end and a bottom end, wherein the elongated member exhibits no flex memory;
wherein the elongated member has an exterior surface texture configured to provide purchase to a line attached to the elongated member.

15. The agricultural system of claim 14, wherein the elongated member comprises one of an ellipse cross section, an oval cross section, a rectangular cross section, an octagonal cross section, and a polygon cross section.

16. A method of making an agricultural stake to support plants, the method comprising:
extruding an elongated member to form a thin walled tube that exhibits no flex memory; and
creating an exterior surface texture on the elongated member.

17. The method of claim 16, wherein the exterior surface texture is formed by abrasive blasting.

18. The method of claim 16, wherein the exterior surface texture is formed by sand blasting.

19. The method of claim 16, wherein the exterior surface texture is formed by sandpaper abrasion.

20. The method of claim 16, wherein the exterior surface texture is non-linear.
